(19) United States
(12) Patent Application Publication
(10) Pub. No.: US 2026/0187200 A1
(43) Pub. Date: Jul. 2, 2026

(54) TANGIBLE MUSIC DISTRIBUTION DEVICE

(71) Applicant: Haynie O'Neal Smith, II, Milwaukee, WI (US)

(72) Inventor: Haynie O'Neal Smith, II, Milwaukee, WI (US)

(21) Appl. No.: 19/545,615

(22) Filed: Feb. 20, 2026

Related U.S. Application Data
(63) Continuation-in-part of application No. 17/897,569, filed on Aug. 29, 2022.
(60) Provisional application No. 63/260,687, filed on Aug. 29, 2021.

(51) Int. Cl. G06F 21/10; G06F 16/955; G06F 21/62; G06K 19/06

(52) U.S. Cl. CPC G06F 21/10; G06F 16/9554; G06F 21/6209; G06K 19/06037

(57) ABSTRACT

A digital content access system including: a physical card body; a scannable code disposed on the card body and configured to direct a user device to a content access webpage; a concealed access code located beneath a scratch-off layer on the card body and configured to authorize access to a digital media file; and a printed display region that identifies the media file with at least a title, an author or artist name, and visual artwork. Additionally, a method for distributing digital media through use of a physical access card, including providing a card comprising a scannable code and a concealed access code; instructing a user to scan the scannable code or navigate manually to a content access webpage; receiving the access code from the user at the content access webpage; and granting access to a digital media file upon verification of the access code.

### CROSS REFERENCE TO RELATED APPLICATIONS

This application is a continuation-in-part of U.S. patent application Ser. No. 17/897,569, filed Aug. 29, 2022, which claims priority to U.S. Provisional Patent Application No. 63/260,687, filed Aug. 29, 2021, the entire disclosures of which are incorporated herein by reference.

### FIELD OF THE DISCLOSURE

The present invention relates to a tangible music distribution device. More specifically, the present invention relates to a tangible music distribution device with integrated security features and digital access capabilities.

### BACKGROUND OF THE DISCLOSURE

Physical music sales have been declining due to the rise of digital technology, leading to a decrease in tangible album distribution. Traditional physical music media, such as CDs and vinyl, are costly to manufacture and distribute, making these options undesirable compared to digital music formats. Digital download cards are physical cards that enable customers to purchase and access digital music; however, previous digital download card designs lack cross-platform compatibility. Therefore, there is a need for a cost-effective, compact, and universally accessible music distribution method.

### SUMMARY OF THE DISCLOSURE

The present invention comprises a digital content access system, the digital content access system comprising a physical card body, a scannable code disposed on the card body and configured to direct a user device to a content access webpage, a concealed access code located beneath a scratch-off layer on the card body, the access code being configured to authorize access to a digital media file, and a printed display region that identifies the media file with at least a title, an author or artist name, and visual artwork.

The present invention also comprises a method for distributing digital media through use of a physical access card, the method comprising providing a card comprising a scannable code and a concealed access code, instructing a user to scan the scannable code or navigate manually to a content access webpage, receiving the access code from the user at the content access webpage, and granting access to a digital media file upon verification of the access code.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is a front view of the Music Card.

FIG. 2A is a back view of the Music Card including the scratch-off layer to conceal the access code.

FIG. 2B is a back view of the Music Card without the scratch-off layer to reveal the access code.

FIG. 3A is an example of a content access webpage prior to access code entry.

FIG. 3B is an example of a content access webpage following access code entry.

FIG. 4 is a flow diagram of the music access system process.

FIG. 5A is an example of a content access webpage following confirmation of the access code and prior to agreeing to the digital privacy policy.

FIG. 5B is an example of a content access webpage following confirmation of the access code and agreement to the digital privacy policy, such that the download link is displayed.

FIG. 6 is an example of an error message following entry of an invalid access code.

FIG. 7 is an example of a downloaded digital media file.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

The Music Card is a retail-ready, 3.375×4-inch plastic card with an attached or detachable hang tag, designed for artists and record companies to distribute music via a unique digital download system. The card features a secure scratch-off concealed code, a QR code for direct access, and printed album-related details. It is designed to function both as a secure digital download key and as a collectible memorabilia item.

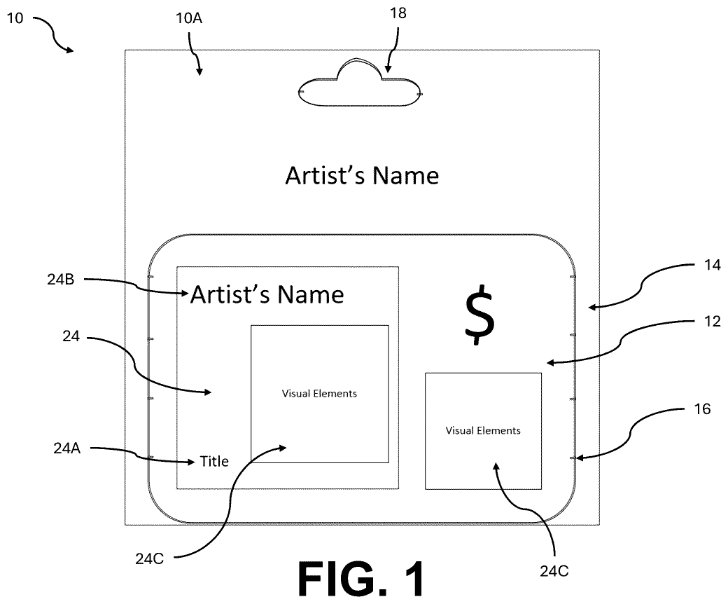

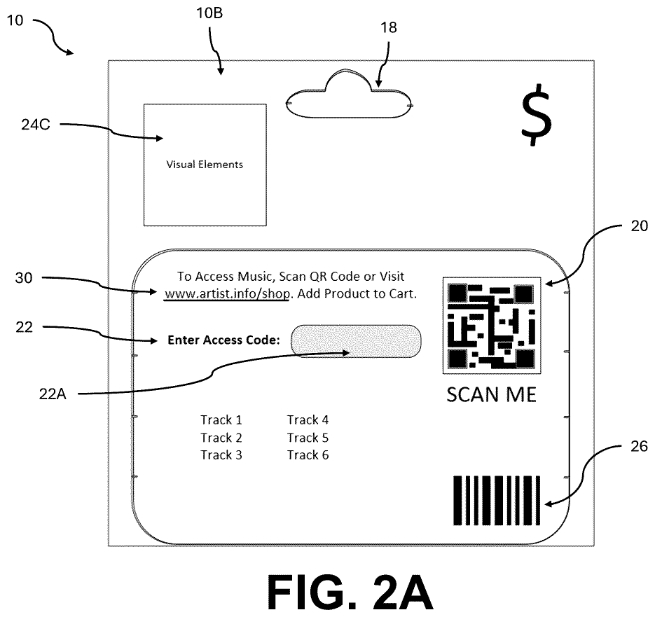

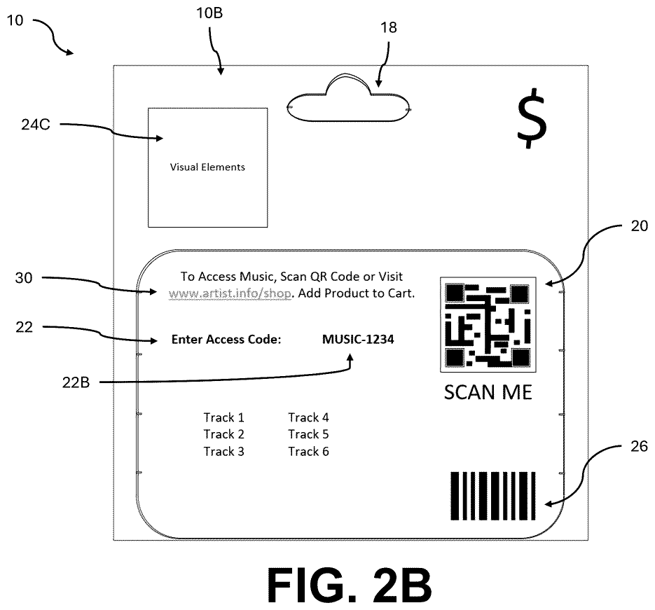

More specifically, referring to FIG. 1, a tangible music distribution device, or “Music Card” 10, is a device with a card-like shape comprising a front surface 10A (as shown in FIG. 1) and a back surface 10B (as shown in FIG. 2). The Music Card 10 has an inner portion 12 and outer portion 14. A plurality of thin frangible spokes 16 integrally connect the inner portion 12 and outer portion 14. The spokes 16 are designed to break when the user detaches the inner portion 12 from the outer portion 14. Once the spokes 16 are broken, the inner portion 12 and outer portion 14 are permanently detached.

The outer portion 14 has a hanging portion 18 that is initially integral with the outer portion 14 by a plurality of thin frangible spokes 16. The spokes 16 are designed to break when the user detaches the outer portion 14 from hanging portion 18. Once the spokes 16 are broken, the hang portion 18 is permanently detached from the outer portion 14, creating a hanging display 18A (not shown) within the outer portion 14. The hanging display 18A may be an aperture, notch, or reinforced slot. The shape of the hanging display 18A outlines that of the hanging portion 18 and is configured to allow hanging of the outer portion 18; however, it is understood by those skilled in the art that the exact shape of hanging display 18A may vary. More specifically, the hanging display 18A is configured for a retail environment.

The front surface 10A comprises a printed display region 24 that comprises at least a title 24A, author or artist name 24B, and artist-identifying visual elements 24C. The visual elements 24C may be album artwork, track listings, or other forms of artist branding.

Referring now to FIGS. 2A-2B, the back surface 10B of Music Card 10 is shown. More specifically, FIG. 2A is a back view of the Music Card including a scratch-off layer 22A to conceal an access code 22B, and FIG. 2B is a back view of the Music Card without the scratch-off layer 22A to reveal the access code 22B.

Back surface 10B includes a music access system 20 located in the inner portion 12 of the Music Card 10. A music access system 20 is configured to enable the user to access digital music on the user's digital device. The music access system 20 can be in the format of a QR code; however, this format should not be construed as limiting, as any method of allowing digital music access may be considered by those skilled in the arts. The back surface 10B also includes a security feature 22 located in the inner portion 12 of Music Card 10. The security feature 22 is configured to prevent digital access through the music access system 20 until the security feature 22 is activated. One mode of the security feature 22 consists of a scratch off sticker 22A (as shown in FIG. 2A) with an access code 22B (as shown in FIG. 2B). The scratch off sticker 22A is adhered to back surface 10B and completely covers access code 22B when in its initial purchasing state. The access code 22B is concealed beneath the scratch-off layer 22A on the card body 10.

The back surface 10B further comprises a UPC barcode 26 that is configured for compatibility with retail point-of-sale systems and automated inventory management. The UPC barcode 26 is used in coordination with retail purchase to activate or log the access code 22B associated with the physical card 10.

The user can purchase the card from a retail point-of-sale system using the UPC barcode 26. After purchasing the physical card 10, when the user wants to access music digitally for the first time, the user must digitally navigate to a content access webpage 28 using a digital device such as a cellphone, tablet, or computer. The content access webpage 28 is configured to be a hosted digital storefront. The process of navigating to the content access webpage 28 is defined as the music access system 20.

The music access system 20, in other words, is configured to direct a user device to the content access webpage 28. The music access system 20 may comprise a QR code that, when scanned, automatically redirects to a content access webpage 28 associated with a unique webpage URL 30 hosted by a content provider. The user may instead elect to manually enter the webpage URL 30 as provided on the back surface of the Music Card 10B.

Once the user is directed to the content access webpage 28, the user may remove scratch off sticker 22A to reveal the access code 22B, as shown in FIG. 2B. Access code 22B is a unique code that may be printed onto the back surface 10B of the Music Card 10. Using the access code 22B, the user can digitally access music (upon verification of the access code 22B) as will be discussed in more detail below.

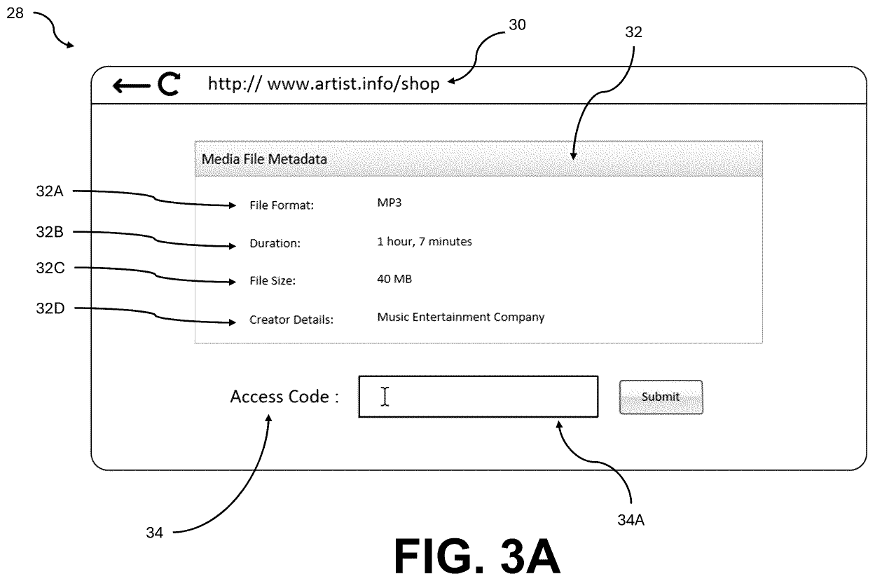

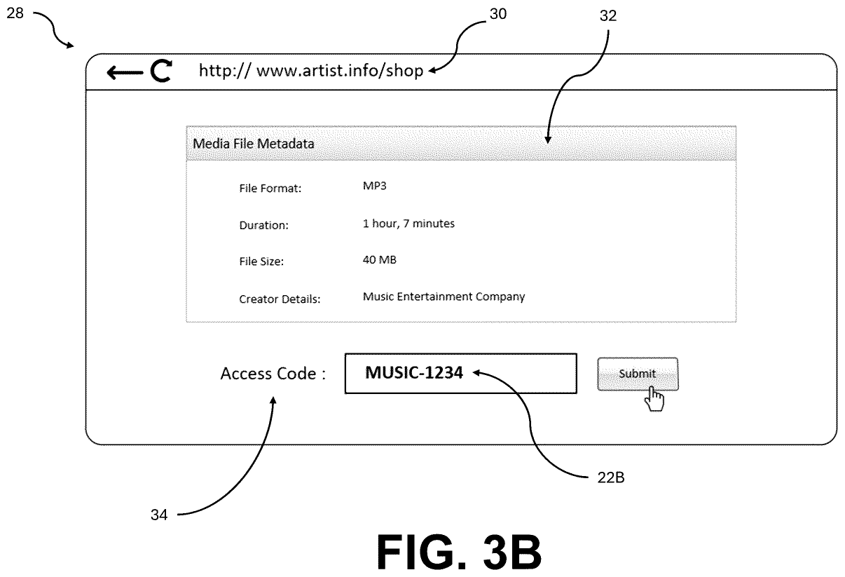

FIGS. 3A and 3B illustrate the content access webpage 28 prior to and following access code 22B entry, respectively. The content access webpage 28 presents metadata 32 associated with the media file, including file format 32A, duration 32B, file size 32C, and creator details 32D. The webpage 28 includes an access code entry portion 34 comprising a manual entry option 34A. The manual entry option 34A allows the user to enter the access code 22B on the content access webpage 28. The access code 22B is configured to authorize access to a digital media file 40, as will be further discussed below.

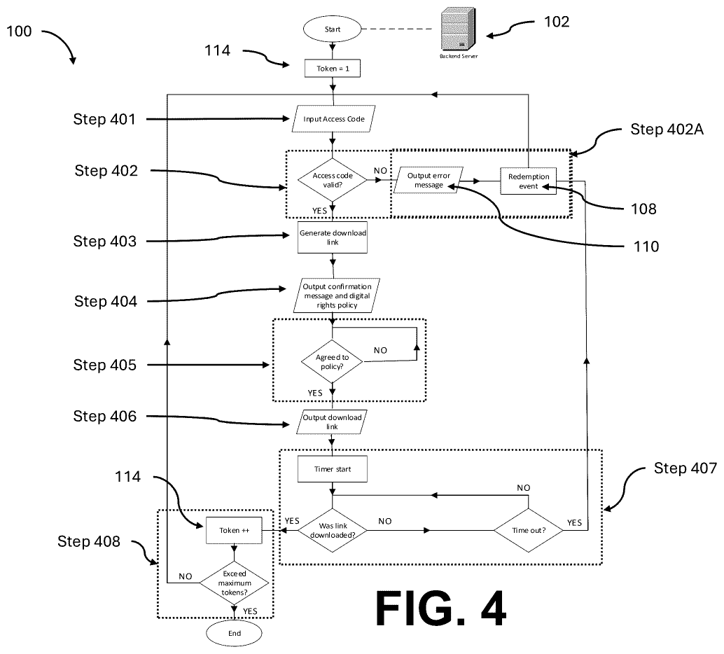

FIG. 4 is a flow diagram illustrating the digital process 100 of digitally accessing music through a backend server 102, starting with entry of the access code 22B (Step 401). More specifically, the backend server 102 is configured to validate the access code 22B (Step 402), generate user-specific credentials (Step 403), and manage access time and/or token expiration (Steps 407 and 408, respectively).

Entry of the access code 22B into the access code entry portion 34 (Step 401) triggers validation against a remote server database (Step 402). The remote server database comprises valid access code information and is configured to confirm the validity of the access code 22B entered. The remote server database may be stored within the backend server 102.

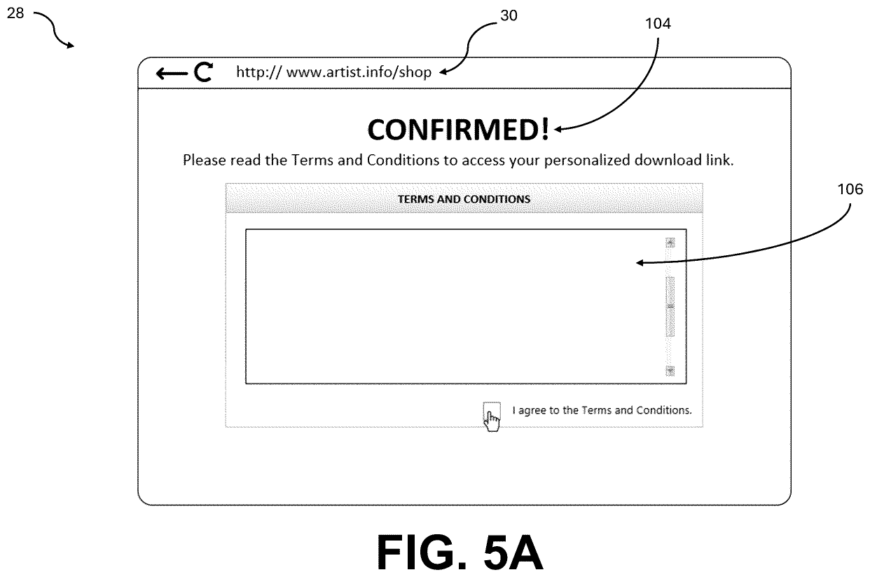

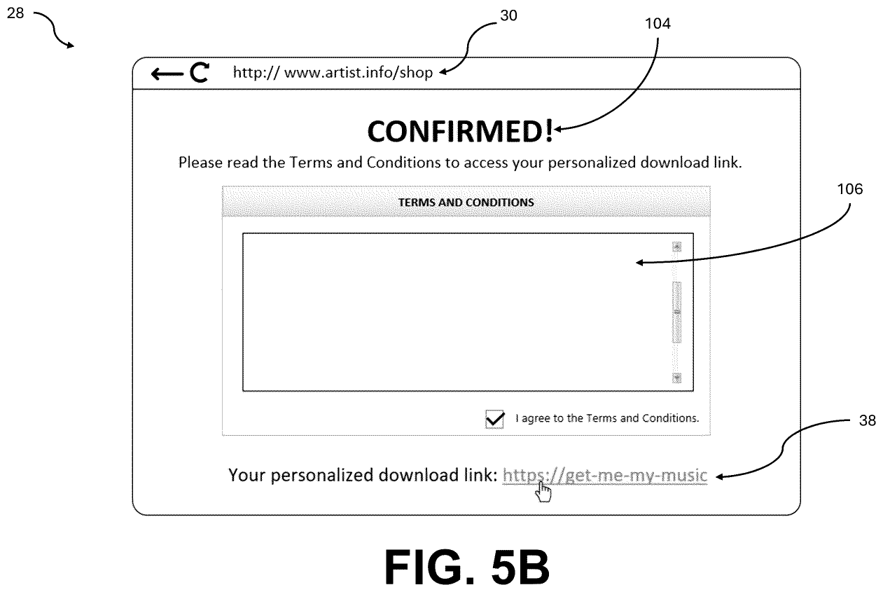

Upon confirmation, the backend server 102 generates a secure download link 38 (Step 403) and the webpage 28 displays both a confirmation notification 104 and a usage license or digital rights policy 106 to the user (Step 404). An example content access webpage 28 displaying the confirmation notification 104 and digital rights policy 106 can be seen in FIGS. 5A-5B. The usage license or digital rights policy 106 is presented on the content access webpage 28 prior to download. The user is required to agree to the license or policy 106 to trigger the transmission of the download link 38. As shown in FIG. 5A, prior to accepting the license or policy 106, the user does not have access to the generated download link 38. The backend server 102 validates the acceptance of the license or policy 106 (Step 405). Following user acceptance of the license or policy 106, the secure download link 38 is transmitted to the user for download of a digital media file 40 (Step 406). The download link 38 may be transmitted to the user via email, text message, browser interface (as shown in FIG. 5B), or other modes of communication through user-provided credentials. The download link 38 remains valid for a limited duration (Step 407) or access count (Step 408), which are added security features of the present design.

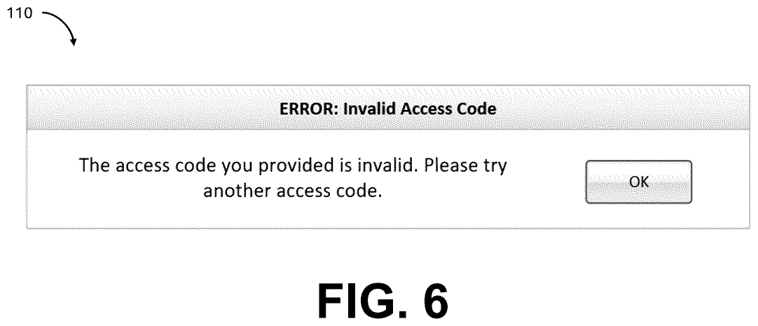

If the access code 22B is invalid, the backend server 102 triggers a redemption system (Step 402A). The redemption system comprises at least one processing module and database that tracks code activation status, enforces single-use limits, and links redemptions to card purchase data. If the access code 22B is invalid, the server 102 will not generate a secure download link 38 and the webpage 28 transmits an error message 110 (shown in FIG. 6) configured to notify the user that the access code 22B entered is invalid. The user may complete a redemption event 108 such as manually reentering the access code 22B. Redemption events 108 are configured to retrigger validation through the remote server database. The redemption system will continue to loop until a valid access code 22B is confirmed, which only then the server 102 will generate the download link 38 (Step 403) and display the confirmation message 104 and policy or licensing agreement 106 (Step 404). The server 102 may additionally transmit a confirmation or redemption notification to an account associated with a content distributor, publisher, or artist (not shown).

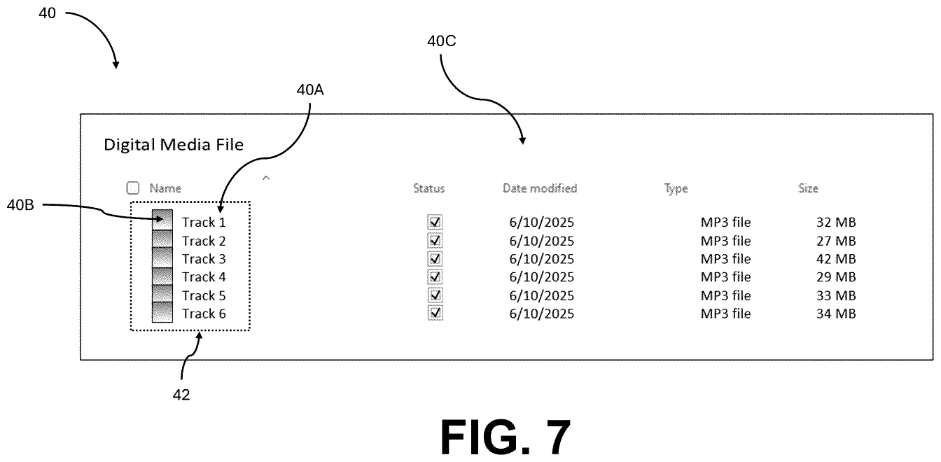

Referring now to FIG. 7, once the download link 38 is transmitted to the user (Step 406), the user may now access or download the link 38. When the user accesses or presses the download link 38, the digital media file 40 will begin to download onto the user's digital device. The digital media file 40 comprises a compressed archive of multiple files including audio tracks 40A, cover images 40B, and descriptive metadata 40C. The user may now access the digital media file 40 on their digital device. The digital media file 40 includes one or more audio tracks 40A formatted in a platform-compatible file type and organized by a predefined track-list 42. The track-list 42 and its associated metadata may be printed on the physical Music Card 10 to provide a physical reference for the user.

Referring back to FIG. 4, time-sensitive credentials (Step 407) such as a maximum time duration between transmission and access of the link 38 may be implemented as an added security feature. If the download link 38 is not accessed or downloaded during the maximum time duration, the download link 38 will expire, triggering the redemption system (Step 402A). The user must then complete a redemption event 108 to generate and obtain a new download link 38. Redemption events 108 may be logged with timestamp and IP metadata on the backend server 102.

The redemption system 108 may also comprise an access count or tokens 114 to prevent unauthorized reuse or redistribution of the digital media file 40. The Music Card 10 may be designated as reusable or non-reusable via a flag stored in the redemption system 108 and surfaces to the content access webpage 28 during the digital access process 100. Once the download link 38 reaches the maximum amount of allowable access tokens 114, the user will be unable to download the digital media file 40 using the download link 38 (Step 408). For example, the flag may designate the card 10 to be non-reusable, thereby allowing only one access token 114. The backend server 102 will limit the download link 38 to a one-time use, effectively allowing download of the digital media file 40 to only one device.

The Music Card 10 introduces a novel form of physical media distribution by combining the tangible presentation of traditional physical formats (e.g., vinyl, CDs, cassettes) with a digital redemption system. The digital music access system 20 is embedded within the prepaid, retail-distributed card 10. Unlike conventional gift cards or access codes, the Music Card 10 uniquely integrates artist-identifying visual elements 24C with a security feature 22 comprising a scannable access code 22B and concealed scratch-off sticker 22A. The access code 22B directs a user to a hosted digital storefront 28. Upon validation, the music access system 20 records the price of the album, enables download access compatible with all internet-connected devices, and issues a time-limited download link 38. The system 20 may issue the download link 38 through various communication channels, such as email or a text message. This hybrid structure creates a merchandising-ready, stand-alone product that functions as both memorabilia and a secure conduit for licensed digital media delivery - bridging retail point-of-sale systems with backend-controlled digital access protocols in a user-friendly, format-preserving experience.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

Terms such as “about” or “approximately”, unless otherwise defined or restricted in the specification, should be understood to define a variance of plus or minus 5%-10% to the numerical term referred to.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed. The various embodiments and elements can be interchanged or combined in any suitable manner as necessary.

The use of directions, such as forward, rearward, top and bottom, upper and lower are with reference to the embodiments shown in the drawings and, thus, should not be taken as restrictive. Reversing or flipping the embodiments in the drawings would, of course, result in consistent reversal or flipping of the terminology.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalent.

What is claimed is:

1. A digital content access system comprising:
a physical card body;
a scannable code disposed on the card body and configured to direct a user device to a content access webpage;
a concealed access code located beneath a scratch-off layer on the card body, the access code being configured to authorize access to a digital media file; and
a printed display region that identifies the media file with at least a title, an author or artist name, and visual artwork.

2. The system of 1, wherein the card body comprises a structure configured for hanging display in a retail environment, such as an aperture, notch, or reinforced slot.

3. The system of 2, wherein the card body further comprises a UPC barcode configured for compatibility with retail point-of-sale systems and automated inventory management.

4. The system of 3, wherein the UPC barcode is used in coordination with retail purchase to activate or log the access code associated with the card.

5. The system of 1, wherein the scannable code comprises a two-dimensional barcode that, when scanned, links to a content access webpage associated with a unique URL hosted by a content provider.

6. The system of 5, wherein the content access webpage presents metadata associated with the media file, including file format, duration, file size, and creator details, prior to download.

7. The system of 6, wherein the webpage includes both automatic redirection via code scan and a manual entry option for the access code and destination URL.

8. The system of 1, wherein entry of the access code on the content access webpage triggers validation against a remote server database and, upon confirmation, generates a secure download link for the media file.

9. The system of 8, wherein the secure download link is transmitted to a user-provided email address and remains valid for a limited duration or access count.

10. The system of 9, wherein the digital media file comprises a compressed archive of multiple files including audio recordings, cover images, and descriptive metadata.

11. A method for distributing digital media through use of a physical access card, the method comprising:
providing a card comprising a scannable code and a concealed access code;
instructing a user to scan the scannable code or navigate manually to a content access webpage;
receiving the access code from the user at the content access webpage; and
granting access to a digital media file upon verification of the access code.

12. The method of 11, further comprising generating a download link specific to the access code and transmitting it to the user via an email or browser interface.

13. The method of 12, wherein the download link is embedded with time-sensitive credentials or access tokens to prevent unauthorized reuse, and wherein redemption events are logged with timestamp and IP metadata.

14. The method of 13, wherein the system transmits a confirmation or redemption notification to an account associated with a content distributor, publisher, or artist.

15. The method of 11, wherein the digital media file includes one or more audio tracks formatted in a platform-compatible file type and organized by a predefined tracklist.

16. The method of 15, wherein the tracklist and associated metadata are also printed on the access card to provide a physical reference for the user.

17. The method of 11, further comprising requiring the user to agree to a usage license or digital rights policy presented on the content access webpage prior to download.

18. The method of 11, wherein a backend server is configured to validate the access code, generate user-specific credentials, and manage access token expiration.

19. The method of 18, wherein a redemption system comprising at least one processing module and database tracks code activation status, enforces single-use limits, and links redemptions to card purchase data.

20. The method of 19, wherein the card is optionally designated as reusable or non-reusable via a flag stored in the redemption system and surfaced to the user interface during the access process.
